(19) United States
(12) Patent Application Publication
(10) Pub. No.: US 2026/0134585 A1
(43) Pub. Date: May 14, 2026

(54) ONE-STEP INFERENCE FOR PRIOR MODEL IN TEXT-TO-IMAGE SYNTHESIS

(71) Applicant: ADOBE INC., SAN JOSE, CA (US)

(72) Inventors: Vinh Ngoc Khuc, San Jose, CA (US); Midhun Harikumar, Sunnyvale, CA (US); Ajinkya Gorakhnath Kale, San Jose, CA (US)

(21) Appl. No.: 18/948,039

(22) Filed: Nov. 14, 2024

(51) Int. Cl. G06T 11/00; G06F 40/284

(52) U.S. Cl. CPC G06T 11/00; G06F 40/284

(57) ABSTRACT

A method, apparatus, non-transitory computer readable medium, and system for image processing include obtaining a text prompt describing an image element, generating an image embedding based on the text prompt, where the image embedding represents visual features of the image element, and generating a synthetic image depicting the image element based on the image embedding.

### BACKGROUND

The following relates generally to image processing, and more specifically to image generation using a machine learning model. Image processing refers to the use of a computer to edit an image using an algorithm or a processing network. In some cases, image processing software can be used for various image processing tasks, such as image restoration, image detection, image editing, image compositing, and image generation. For example, image generation includes the use of a machine learning model to generate a synthetic image based on an input such as a text prompt, an image, or a style.

### SUMMARY

Aspects of the present disclosure provide a method and system for text-to-image generation. In one aspect, the system receives an input prompt and generates a synthetic image depicting an image element described by the input prompt. According to some aspects, the system includes a transformer prior model trained to generate an image embedding based on the input prompt. In one aspect, the transformer prior model tokenizes the input prompt into a plurality of text token. The transformer prior model generates text token embeddings based on the text tokens. The transformer prior model generates partial image embeddings based on the text token embeddings. In one aspect, the image embedding represents visual features of the image element described by the input prompt. In some aspects, the system includes an image generation model configured to generate the synthetic image based on the image embedding.

A method, apparatus, non-transitory computer readable medium, and system for image processing include obtaining a text prompt describing an image element, generating, using a transformer prior model, an image embedding based on the text prompt, where the image embedding represents visual features of the image element, and generating, using an image generation model, a synthetic image depicting the image element based on the image embedding.

A method, apparatus, non-transitory computer readable medium, and system for image processing include obtaining a training set comprising a text prompt and a ground-truth image, wherein the text prompt describes an image element, and training, using the training set, a transformer prior model to generate an image embedding that represents visual features of the image element based on the text prompt.

An apparatus and system for image processing include at least one processor, at least one memory storing instructions executable by the at least one processor, a transformer prior model comprising parameters stored in the at least one memory and trained to generate an image embedding based on a text prompt describing an image element, where the image embedding represents visual features of the image element, and an image generation model comprising parameters stored in the at least one memory and configured to generate a synthetic image depicting the image element based on the image embedding.

### BRIEF DESCRIPTION OF THE DRAWINGS

FIG. 1 shows an example of an image processing system according to aspects of the present disclosure.

FIG. 2 shows an example of a method for text conditional image generation according to aspects of the present disclosure.

FIG. 3 shows an example of text-to-image generation according to aspects of the present disclosure.

FIG. 4 shows an example of a method for generating a synthetic image based on a text prompt according to aspects of the present disclosure.

FIG. 5 shows an example of an image processing apparatus according to aspects of the present disclosure.

FIG. 6 shows an example of a text-to-image generation system according to aspects of the present disclosure.

FIG. 7 shows an example of a transformer prior model according to aspects of the present disclosure.

FIG. 8 shows an example of an image generation model according to aspects of the present disclosure.

FIG. 9 shows an example of a U-Net architecture according to aspects of the present disclosure.

FIG. 10 shows an example of a diffusion process according to aspects of the present disclosure.

FIG. 11 shows an example of a method for training a transformer prior model according to aspects of the present disclosure.

FIG. 12 shows an example of a flow diagram depicting an algorithm as a step-by-step procedure in an example implementation of operations performable for training a machine learning model according to aspects of the present disclosure.

FIG. 13 shows an example of a method for training a diffusion model according to aspects of the present disclosure.

FIG. 14 shows an example of a computing device according to aspects of the present disclosure.

### DETAILED DESCRIPTION

The following relates to text-to-image generation using generative machine learning. Embodiments of the disclosure relate to an image generation system that efficiently generates images from an input text prompt. In one aspect, the system includes a transformer prior model trained to generate an image embedding based on a text prompt. By using the generated image embedding in the image generation process, the system ensures accurate image content generation while reducing inference speed, thereby improving model efficiency.

According to some embodiments, the system includes a transformer prior model trained to directly generate an image embedding based on an input text prompt. For example, the image embedding represents the visual features of an image element described by the input text prompt. In some embodiments, the transformer prior model tokenizes the text prompt to obtain a plurality of text tokens. In some embodiments, the transformer prior model generates a plurality of text token embeddings based on the plurality of text tokens. In some cases, each of the plurality of text token embedding represents text features. In some embodiments, the transformer prior model generates intermediate embeddings based on the plurality of text token embeddings. In some cases, each of the plurality of intermediate embeddings represents partial text features and partial visual features of the image element. In some embodiments, the transformer prior model generates a plurality of image token embeddings based on the plurality of intermediate embeddings. In some cases, the plurality of image token embeddings are combined to generate the image embedding.

According to some embodiments, the system includes an image generation model configured to generate the synthetic image based on the generated image embedding. In some cases, image embedding captures the visual features, which ensures more accurate and detailed image generation. In some cases, generating synthetic images using image embeddings instead of text embeddings ensures high-precision and high-fidelity image generation.

A subfield in image processing relates to text-to-image generation. For example, conventional image generation systems receive input conditions such as a text prompt to generate output images. In some cases, these systems are trained to generate images that are closely aligned with the user-provided text prompts. In some cases, a common objective of these systems is to ensure that the generated images are relevant to the input text prompt and have an aesthetic appeal that satisfies the user experience.

In some cases, for example, some conventional systems include a text encoder that converts the text input into a text embedding. Then, these systems use a diffusion-based image decoder to generate output images based on the text embedding. In some cases, these systems also include an upscaling model (or a separate model) that upscales the low-resolution output images to a higher resolution. However, the processing time for these systems may be high due to the complex system architecture. In addition, the output image might not align with the input text prompt, because the text embedding does not include visual feature representations.

Some conventional systems include a pre-trained text encoder and a large diffusion model that generates high-resolution, photorealistic images based on an input text prompt. For example, these systems include a pre-trained text encoder like T5 to generate text embeddings. Then, the large diffusion model initiates with a random noise vector and conditions the generations based on the text embedding. In some cases, these systems include an image decoder that iteratively removes noise, guided by the text embeddings, to generate the images. However, due to the large model parameter, the processing time for these systems is high.

To tackle the issue of high processing time, some conventional systems include a prior model that converts a text embedding into an image embedding. For example, these systems use a pre-trained text encoder that encodes the input text prompt to generate a text embedding, which captures the semantic and contextual information of the input description. Then, the text embedding is passed through a prior model that converts the text embedding into an image embedding. In some cases, the prior model may be an autoregressive prior or a diffusion prior. For example, the autoregressive prior model converts the text embedding into the image embedding by predicting the next token in the sequence based on the previous tokens. For example, the diffusion prior model is a diffusion-based model that converts a text embedding into an image embedding by progressively denoising an initial random vector. However, these prior models require a long processing time to convert a text embedding into an image embedding, thereby increasing the overall inference speed of the image generation system. In some cases, reducing the number of sampling steps in the diffusion prior model compromises the quality of the generated image embeddings.

Embodiments of the disclosure improve on conventional image generation models by generating images more efficiently based on an input text prompt. This is achieved using a system that includes a transformer prior model and an image generation model. In one aspect, the transformer prior model is trained specifically to generate an image embedding based on the input text prompt in a single pass. The image embedding generated from the transformer prior model is provided to the image generation model to initiate the image generation process to accurately generate a synthetic image depicting an image element described by the text prompt.

In one aspect, the transformer prior model is trained to tokenize the input text prompt to obtain a plurality of text tokens. Then, the transformer prior model is trained to generate a plurality of text token embeddings based on the plurality of text tokens. In some embodiments, the transformer prior model is trained to generate a plurality of image token embeddings based on the plurality of text token embeddings. By tokenizing the text prompt and processing the text tokens, the system can efficiently generate the image embedding. For example, tokenization reduces the dimensionality of the input space and reduces the burden of the memory unit. In some cases, tokenization results in the detailed representation of the text prompt, and resulting in more precise and context-aware outputs (e.g., the image embedding).

According to some aspects, the image generation model is configured to receive the image embedding and to generate a synthetic image based on the image embedding. By generating the synthetic image using the image embedding of the input text prompt instead of a text embedding of the input text prompt, the system can generate images with high-fidelity visual content, clearer image structures, and/or context-specific details. Additionally, the efficiency of the system is enhanced, and the complexity of the system can be reduced (e.g., fewer model components or model parameters). In some cases, the system can consistently generate high-quality images while minimizing extreme variability in the image generation process.

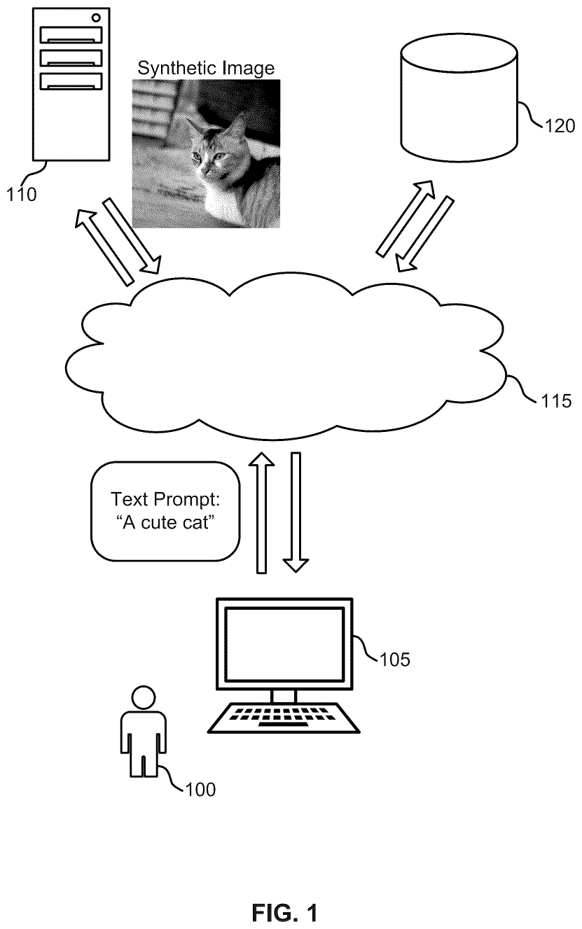

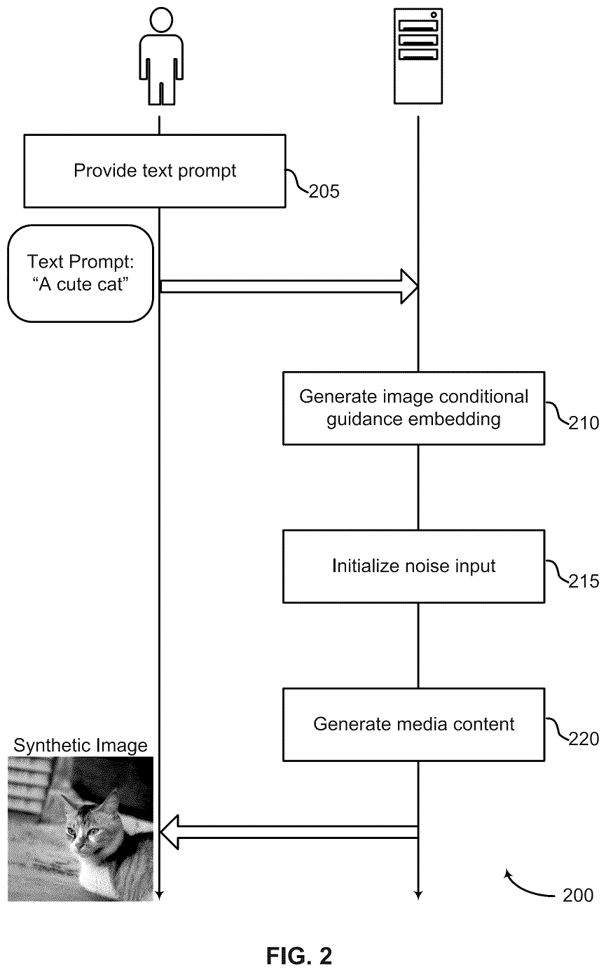

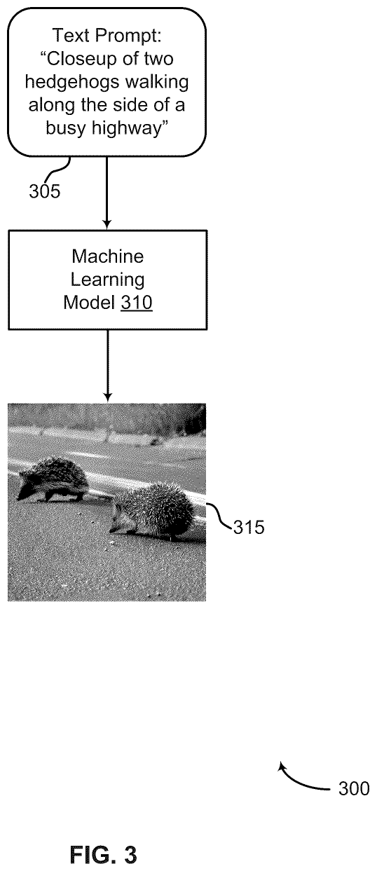

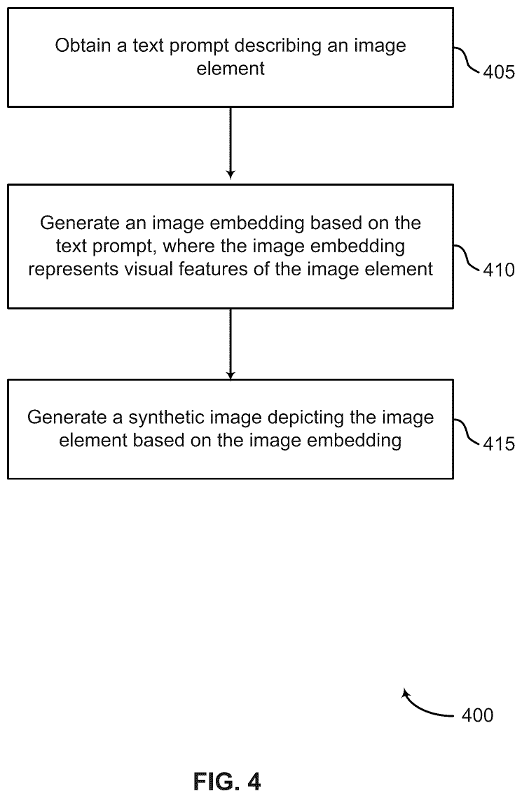

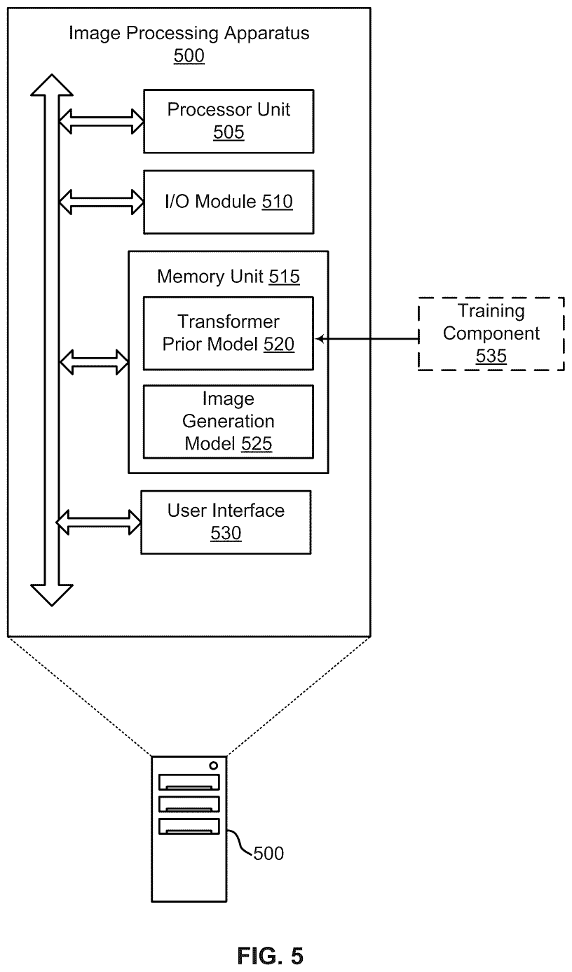

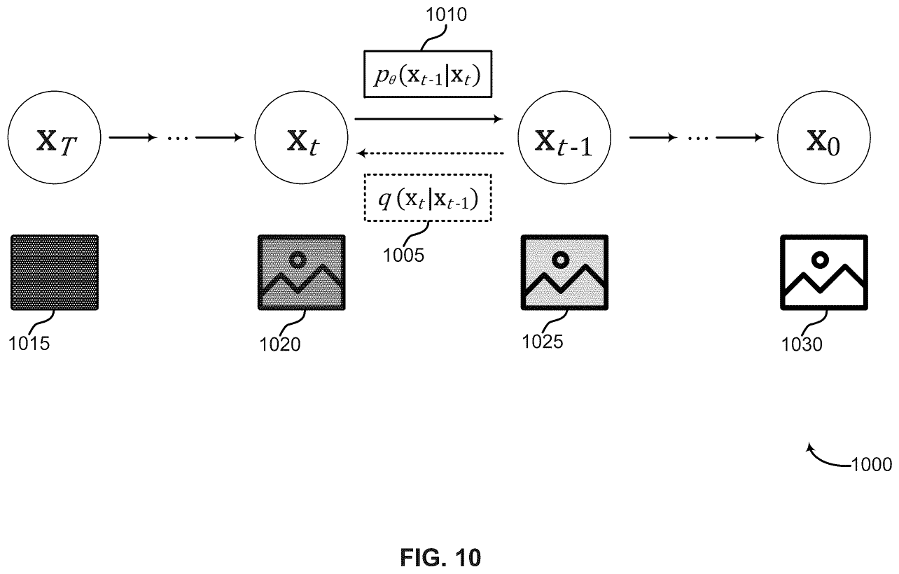

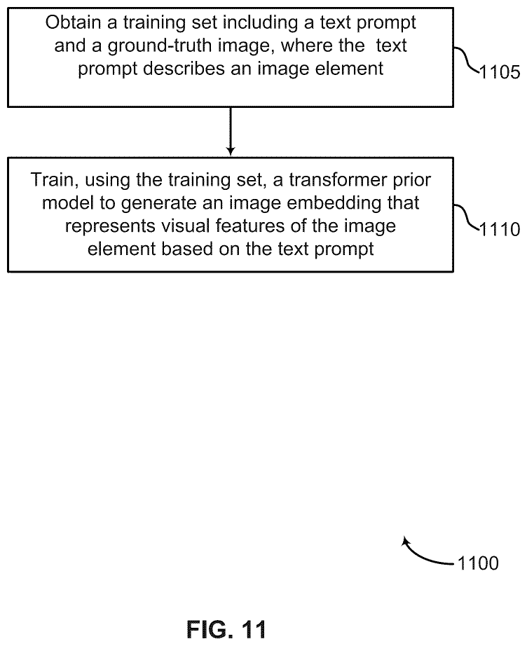

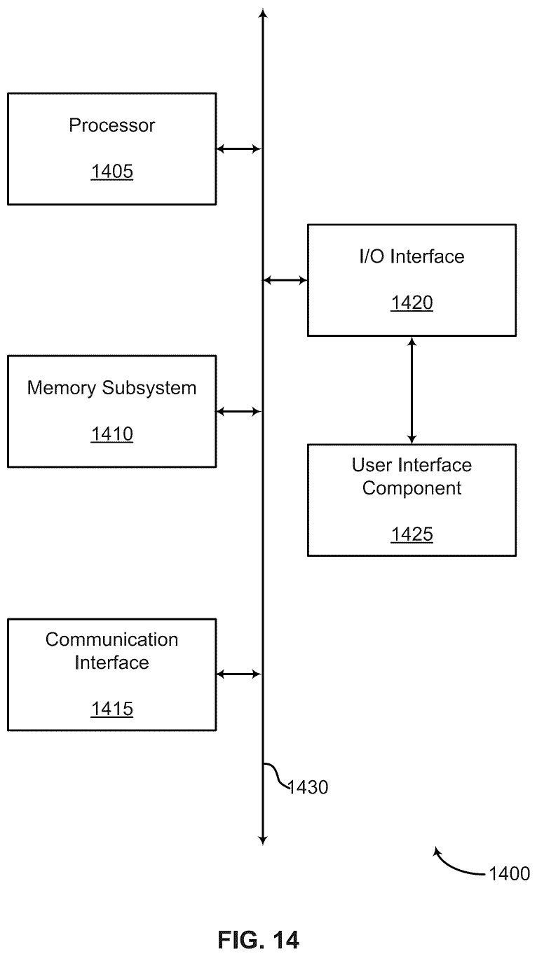

An example system of the inventive concept in image processing is provided with reference to FIGS. 1 and 14. An example application of the inventive concept in image processing is provided with reference to FIGS. 2-3. Details regarding the architecture of an image processing apparatus are provided with reference to FIGS. 5-9. An example of a process for image processing is provided with reference to FIGS. 4 and 10. A description of an example training process is provided with reference to FIGS. 11-13.

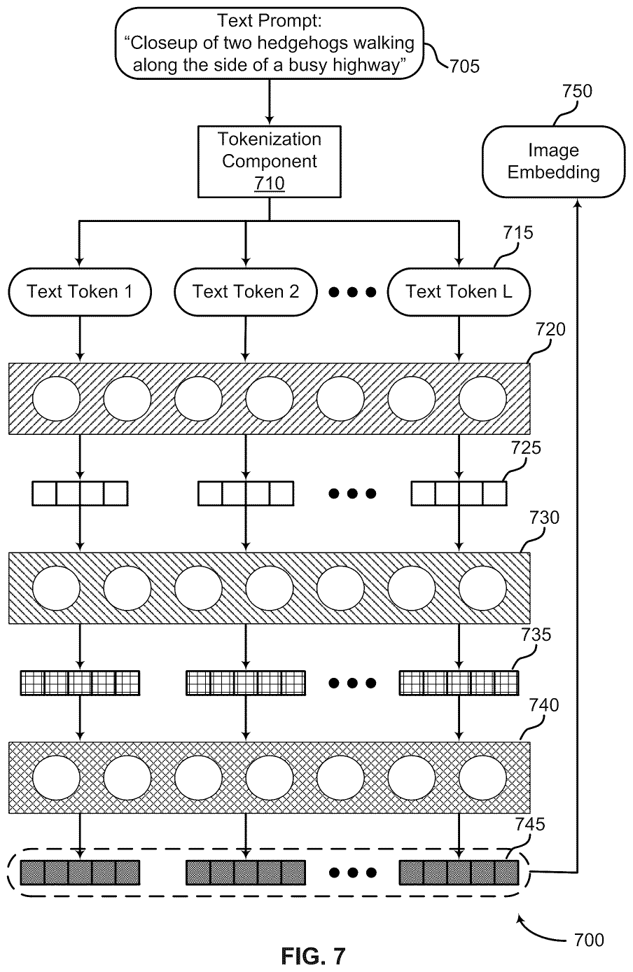

Accordingly, the present disclosure provides a system and method that improve on conventional text-to-image generation models by generating high-fidelity images more efficiently. For example, the system includes a transformer prior model trained to generate an image embedding based on an input text prompt. By generating the image embedding in a single pass using the transformer prior model, the system is able to reduce the overall inference time in the image generation process. In some aspects, the transformer prior model can be used to augment existing diffusion-based text-to-image generative models. Further detail on the transformer prior model is described with reference to FIG. 7.

### Image Processing

In FIGS. 1-4 and 10, a method, apparatus, non-transitory computer readable medium, and system for image processing include obtaining a text prompt describing an image element, generating, using a transformer prior model, an image embedding based on the text prompt, where the image embedding represents visual features of the image element, and generating, using an image generation model, a synthetic image depicting the image element based on the image embedding.

Some examples of the method, apparatus, non-transitory computer readable medium, and system further include tokenizing the text prompt to obtain a plurality of text tokens. In some aspects, the image embedding is generated based on the plurality of text tokens.

Some examples of the method, apparatus, non-transitory computer readable medium, and system further include generating a plurality of text token embeddings based on the plurality of text tokens, respectively. In some aspects, each of the plurality of text token embeddings represent text features. In some aspects, the image embedding is generated based on the plurality of text token embeddings.

Some examples of the method, apparatus, non-transitory computer readable medium, and system further include generating a plurality of partial image embeddings corresponding to the plurality of text tokens, respectively. In some aspects, each of the plurality of partial image embeddings represents partial visual features. Some examples further include combining the plurality of partial image embeddings to obtain the image embedding.

Some examples of the method, apparatus, non-transitory computer readable medium, and system further include obtaining a position embedding for each of the plurality of text tokens. In some aspects, the image embedding is generated based on the position embedding.

Some examples of the method, apparatus, non-transitory computer readable medium, and system further include obtaining a noise input. Some examples further include denoising the noise input based on the image embedding to generate the synthetic image. In some aspects, the transformer prior model is trained to generate image embeddings using a training set comprising a training text prompt and a ground-truth image embedding.

Some embodiments of the method, apparatus, non-transitory computer readable medium, and system for image processing include obtaining a text prompt describing an image element, generating, using a transformer prior model, an image embedding based on the text prompt, where the image embedding represents visual features of the image element, and generating, using an image generation model, a synthetic image based on the image embedding, wherein the synthetic image depicts the image element.

Some examples of the method, apparatus, non-transitory computer readable medium, and system further include tokenizing the text prompt to obtain a plurality of text tokens, wherein the image embedding is generated based on the plurality of text tokens. Some examples of the method, apparatus, non-transitory computer readable medium, and system further include generating, using a first transformer layer of the transformer prior model, a plurality of text token embeddings based on the plurality of text tokens, respectively, wherein each of the plurality of text token embedding represent text features. Some examples of the method, apparatus, non-transitory computer readable medium, and system further include generating, using a second transformer layer of the transformer prior model, a plurality of intermediate embeddings based on the plurality of text token embeddings, wherein each of the plurality of intermediate embeddings represent partial text features and partial visual features. Some examples of the method, apparatus, non-transitory computer readable medium, and system further include generating, using a third transformer layer of the transformer prior model, a plurality of image token embeddings based on the plurality of intermediate embeddings, wherein the image embedding is generated based on the plurality of image token embeddings.

Some examples of the method, apparatus, non-transitory computer readable medium, and system further include generating a first intermediate embedding based on a first text token embedding. Some examples of the method, apparatus, non-transitory computer readable medium, and system further include generating a second intermediate embedding based on the first text token embedding and a second text token embedding.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 5.

Referring to FIG. 1, user 100 provides a text prompt to image processing apparatus 110 via user device 105 and cloud 115. In some cases, the text prompt may be a general description of the image content or image element to be generated in a synthetic image. For example, the text prompt states “A cute cat”. In some embodiments, the image processing apparatus 110 includes a machine learning model that generates an image embedding based on the text prompt. In some cases, the image embedding may be a numerical vector representation that represents the visual features of the text prompt. For example, each numerical value or a group of numerical values of the image embedding may correspond to different attributes of the image to be generated, such as shapes, colors, and/or textures that represent the cute cat. The machine learning model receives the image embedding and generates the synthetic image depicting a cute cat as described by the text prompt. Image processing apparatus 110 displays the synthetic image to user 100 via user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110. In some cases, user device 105 may include a user interface that performs functions of the image processing apparatus 110. User interface may be an example of, or includes aspects of, the corresponding element described with reference to FIG. 5.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIG. 5. According to some aspects, image processing apparatus 110 includes a computer implemented network comprising a machine learning model, a transformer prior model, and an image generation model. Image processing apparatus 110 further includes a processor unit, a memory unit, an I/O module, a user interface, and a training component. In some embodiments, image processing apparatus 110 further includes a communication interface, user interface components, and a bus as described with reference to FIG. 14. Additionally or alternatively, image processing apparatus 110 communicates with user device 105 and database 120 via cloud 115. Further detail regarding the operation of image processing apparatus 110 is described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In some examples, cloud 115 is based on a local collection of switches in a single physical location.

According to some aspects, database 120 stores training data including a training text prompt and a ground-truth image embedding. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for text conditional image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, the system receives a text prompt that describes an image element or image content to be generated in a synthetic image. For example, the text prompt states “A cute cat”. Then, the system generates conditional embedding based on the input. For example, the system generates an image embedding based on the text prompt using a transformer prior model. In some cases, the transformer prior model is trained to generate an image embedding based on a text prompt in a single pass. Further detail on the transformer prior model is described with reference to FIG. 7.

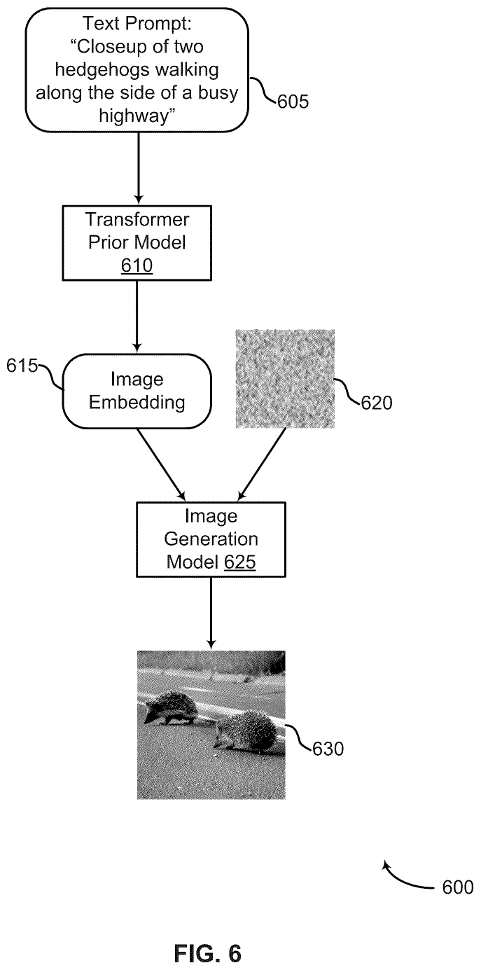

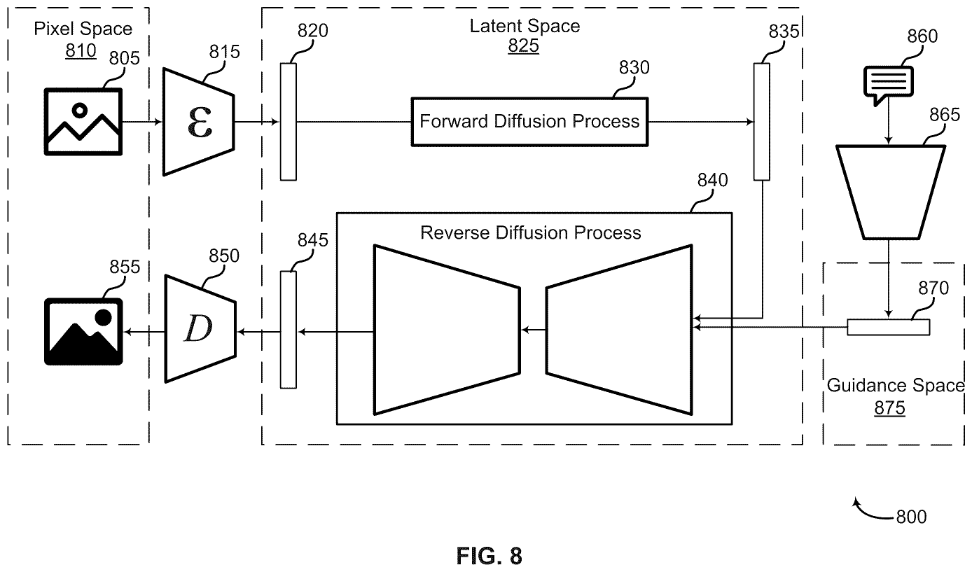

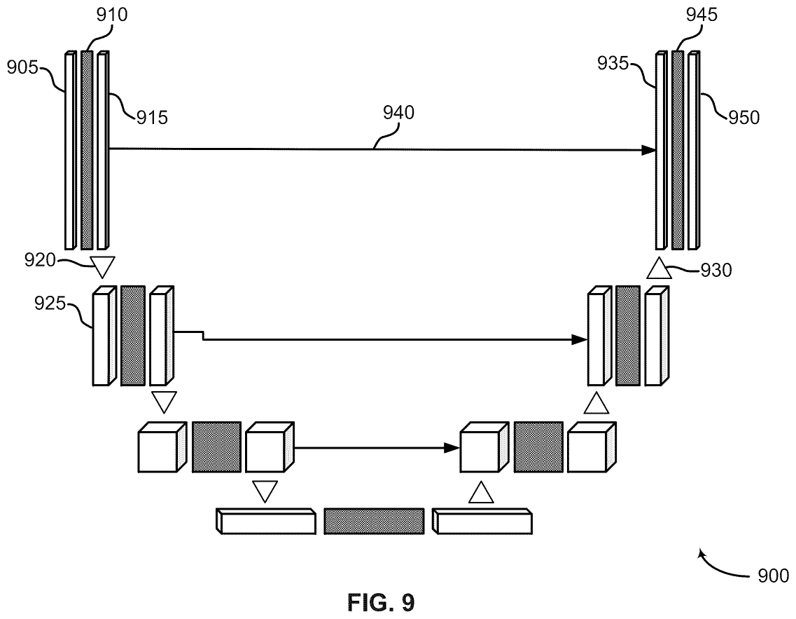

In some embodiments, the system includes an image generation model configured to generate the synthetic image based on the image embedding. In some cases, the image embedding is used to guide the reverse diffusion process in the image generation model. For example, at each diffusion step (or reverse diffusion step), the image embedding provides guidance to the U-Net of the image generation model ensuring that the generated image gradually aligns with the visual characteristics or visual features encoded within the image embedding. Further detail on the image embedding is described with reference to FIG. 7. Further detail on the image generation model is described with reference to FIGS. 6 and 8. Further detail on the U-Net is described with reference to FIG. 9.

At operation 205, the system provides a text prompt. In some cases, the operations of this step refer to, or may be performed by, a user as described with reference to FIG. 1. For example, the user provides a text prompt “A cute cat” to the image processing apparatus via a user interface provided by the image processing apparatus on a user device (e.g., the user device described with reference to FIG. 1). In some cases, for example, the text prompt may be a long, and complex sentence that states “Closeup of two hedgehogs walking along the side of a busy highway” as described with reference to FIG. 3. In some cases, the text prompt describes an image element, for example, the “cute cat” or “cat”.

At operation 210, the system generates image conditional guidance embedding. In some cases, the operations of this step refer to, or may be performed by, an image processing apparatus as described with reference to FIGS. 1 and 5. In some cases, the operations of this step refer to, or may be performed by, a transformer prior model as described with reference to FIGS. 5-7. For example, the transformer prior model tokenizes the text prompt to generate text tokens. In some cases, the transformer prior model generates text token embeddings based on the text tokens. In some cases, the transformer prior model generates image token embeddings based on the text token embeddings. In some cases, the image token embeddings are combined to generate the image embedding. In some embodiments, the image embedding is used to guide the reverse diffusion process to generate the synthetic image. Further detail on the transformer prior model is described with reference to FIG. 7.

At operation 215, the system initializes noise input. In some cases, the operations of this step refer to, or may be performed by, an image processing apparatus as described with reference to FIGS. 1 and 5. In some cases, the operations of this step refer to, or may be performed by, an image generation model as described with reference to FIGS. 5 and 6. In some cases, the noise input including random noise is initialized. The noise input may be in a latent space. By initializing the image generation model with random noise, different variations of a synthetic image including the content described by the text conditioning (e.g., the text prompt) can be generated.

At operation 220, the system generates media content. In some cases, the operations of this step refer to, or may be performed by, an image processing apparatus as described with reference to FIGS. 1 and 5. In some cases, the operations of this step refer to, or may be performed by, an image generation model as described with reference to FIGS. 5 and 6. In some cases, the image generation model generates the synthetic image based on the image embedding. In some cases, the synthetic image depicts the image element described by the text prompt. For example, the synthetic image depicts a cute cat. In some cases, the visual features or visual characteristics of the image element aligns with image element described by the text prompt. In some cases, the synthetic image is returned and displayed to the user via a user interface provided by the image processing apparatus on the user device.

FIG. 3 shows an example of text-to-image generation according to aspects of the present disclosure. The example shown includes image generation system 300, text prompt 305, machine learning model 310, and synthetic image 315. In some embodiments, the image generation system 300 is implemented in a user interface (e.g., the user interface 530 described with reference to FIG. 5) on a user device (e.g., the user device 105 described with reference to FIG. 1).

Referring to FIG. 3, image generation system 300 generates synthetic image 315 based on text prompt 305. For example, text prompt 305 states “Closeup of two hedgehogs walking along the side of a busy highway”. In some aspects, machine learning model 310 includes a transformer prior model trained to directly generate image embedding based on the text prompt 305. In some cases, the image embedding represents visual features of the text prompt 305. For example, each numerical value or a group of numerical values of the image embedding may correspond to different attributes of the image to be generated, such as shapes, colors, and/or textures that represent one or more image elements described in the text prompt 305. Further detail on the transformer prior model is described with reference to FIG. 7. Further detail on the image embedding is described with reference to FIG. 7.

According to some embodiments, the machine learning model 310 includes an image generation model configured to generate the synthetic image 315 based on the image embedding. For example, the image generation model initiates the reverse diffusion process using random noise (e.g., noise input 620 described with reference to FIG. 6). At each reverse diffusion timestep, the image embedding is used to guide the denoising process within the U-Net of the image generation model ensuring that the generated image (or the intermediate images described with reference to FIG. 10) gradually aligns with the visual features encoded within the image embedding. In some cases, for example, the synthetic image 315 depicts two hedgehogs walking along the side of a busy highway. Further detail on the reverse diffusion process is described with reference to FIG. 10.

In some cases, a conventional image generation system generates a conventional synthetic image based on the text prompt 305. For example, the conventional system may include a pre-trained text encoder configured to generate a text embedding based on the text prompt 305. Then, the conventional system includes a prior model that converts the text embedding into an image embedding. In some cases, the prior model is a diffusion-based prior model that includes an iterative process beginning from a noisy state (e.g., a noisy version of text embedding) and gradually reduces the noise to obtain the final output (e.g., the predicted image embedding of the text prompt 305). Then, the conventional system includes an image generation model that generates a conventional synthetic image based on the predicted image embedding.

However, the inference time (e.g., the time to generate an image from the input text prompt) is long due to the complex system architecture and iterative property of the prior model. Accordingly, the machine learning model 310 of the disclosure can generate synthetic images with image quality that is at least comparable to, or even better than, the conventional synthetic images. Additionally, the image generation system 300 of the disclosure can generate images much faster than the conventional image generation systems while maintaining the image quality level.

Text prompt 305 is an example of, or includes aspects of, the corresponding element described with reference to FIGS. 6-8. Synthetic image 315 is an example of, or includes aspects of, the corresponding element described with reference to FIG. 6.

FIG. 4 shows an example of a method 400 for generating a synthetic image based on a text prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the system obtains a text prompt describing an image element. In some cases, the operations of this step refer to, or may be performed by, a transformer prior model as described with reference to FIGS. 5-7. In some cases, the text prompt describes one or more image elements to be generated in a synthetic image. For example, an image element is an image component or image feature that makes up the overall composition of an image, such as an object, entity, subject, shape, color, texture, pattern, background scene, visual attributes, and/or style. For example, the image element may be an animal such as a cat or dog, a person, an object such as a hat or table, a scene such as a beach or mountain top, or a combination thereof.

At operation 410, the system generates, using a transformer prior model, an image embedding based on the text prompt, where the image embedding represents visual features of the image element. In some cases, the operations of this step refer to, or may be performed by, a transformer prior model as described with reference to FIGS. 5-7. In some cases, the image embedding is a numerical (or vector) representation of an image in a high-dimensional vector space. For example, image embedding captures the essential visual features or visual characteristics of an image, such as color, texture, shape, and spatial relationships. In some aspects, the transformer prior model is trained to generate image embeddings based on the text prompt, where the image embedding includes visual features of the image element described by the text prompt.

In some cases, a text embedding is a numerical vector that captures the semantic meaning of the text, encoding words, phrases, or sentences into a dense, continuous space. For example, the text embedding is encoded into a text embedding space, which is a low-dimensional vector space. The text embedding is generated by passing the text prompt through an encoder (e.g., a text encoder or multi-modal encoder) that learns the relationships between words based on the context within large corpora of text. In some cases, the text embedding represents textual features (e.g., the semantic meaning, relationship between words, or lexical features) of the text prompt.

In some cases, a text embedding space is a continuous, low-dimensional vector space where each vector represents the semantic meaning of the text. Points in the text embedding space are organized such that text with similar meanings are located near each other, reflecting the relationships between different words, phrases, or sentences based on contextual usage.

In some cases, an image embedding space is a high-dimensional vector space where each point corresponds to an image's visual representation. In the image embedding space, the distance between points reflects the similarity of the visual features of the images. In some cases, similar images are located closer to each other based on the characteristics encoded in the image embeddings.

In some cases, the image embedding generated from the transformer prior model may be in a multimodal embedding space. For example, the multimodal embedding space (also known as a joint embedding space) is a high-dimensional space where different types of data (modalities), such as text, images, audio, or video, are represented in a unified manner. In the joint embedding space, data from various modalities are encoded into vectors that can be compared and related to each other directly, even though the data originate from different sources. For example, the text embedding of the text description “a cute cat” and the image embedding of the image of a cute cat would be mapped to nearby points in the joint embedding space. In some cases, the joint embedding space includes a shared semantic space configured to capture shared semantic meanings across modalities, where a text input can be matched to an image or vice versa.

At operation 415, the system generates, using an image generation model, a synthetic image depicting the image element based on the image embedding. In some cases, the operations of this step refer to, or may be performed by, an image generation model as described with reference to FIGS. 5 and 6. In some cases, the system generates one or more synthetic images based on the image embedding, where each of the synthetic images depicts the image element having different variations. Further detail on the image generation model is described with reference to FIGS. 6 and 8.

### System Architecture

In FIGS. 5-9 and 14, an apparatus and system for image processing include at least one processor, at least one memory storing instructions executable by the at least one processor, a transformer prior model comprising parameters stored in the at least one memory and trained to generate an image embedding based on a text prompt describing an image element, where the image embedding represents visual features of the image element, and an image generation model comprising parameters stored in the at least one memory and configured to generate a synthetic image depicting the image element based on the image embedding.

In some aspects, the apparatus comprises a tokenization component configured to tokenize the text prompt to obtain a plurality of text tokens, where the image embedding is generated based on the plurality of text tokens. In some aspects, the image generation model includes a diffusion model. Some examples of the apparatus and system further include a user interface configured to display the synthetic image.

In some aspects, the transformer prior model comprises a first transformer layer trained to generate a plurality of text token embeddings corresponding to the plurality of text tokens, respectively. In some aspects, the transformer prior model comprises a second transformer layer trained to generate a plurality of intermediate embeddings corresponding to the plurality of text token embeddings, respectively. In some aspects, the transformer prior model comprises a third transformer layer trained to generate a plurality of partial image embeddings corresponding to the plurality of intermediate embeddings, respectively.

FIG. 5 shows an example of an image processing apparatus 500 according to aspects of the present disclosure. The example shown includes image processing apparatus 500, processor unit 505, I/O module 510, memory unit 515, user interface 530, and training component 535. In one aspect, memory unit 515 includes transformer prior model 520 and image generation model 525.

According to some embodiments of the present disclosure, image processing apparatus 500 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 500 is an example of, or includes aspects of, the corresponding element described with reference to FIG. 1.

Processor unit 505 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 505 is configured to operate a memory array using a memory controller. In other cases, a memory controller is integrated into the processor. In some cases, processor unit 505 is configured to execute computer-readable instructions stored in a memory to perform various functions. In some embodiments, processor unit 505 includes special-purpose components for modem processing, baseband processing, digital signal processing, or transmission processing. Processor unit 505 is an example of, or includes aspects of, the processor described with reference to FIG. 14.

I/O module 510 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 510 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 510 is an example of, or includes aspects of, the I/O interface described with reference to FIG. 14.

Examples of memory unit 515 include random access memory (RAM), read-only memory (ROM), or a hard disk. Examples of memory unit 515 include solid-state memory and a hard disk drive. In some examples, memory unit 515 is used to store computer-readable, computer-executable software including instructions that, when executed, cause a processor to perform various functions described herein.

In some cases, memory unit 515 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 515 store information in the form of a logical state.

According to some aspects, memory unit 515 includes a machine learning model. In one aspect, the machine learning model includes transformer prior model 520 and image generation model 525. Memory unit 515 is an example of, or includes aspects of, the memory subsystem described with reference to FIG. 14.

In some cases, a machine learning model is a computational algorithm, model, or system designed to recognize patterns, make predictions, or perform a specific task (for example, image processing) without being explicitly programmed. According to some aspects, the machine learning model is implemented as software stored in memory unit 515 and executable by processor unit 505, as firmware, as one or more hardware circuits, or as a combination thereof.

According to some embodiments of the present disclosure, the machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, the machine learning model includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behaviors and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering the relevance of each input element with respect to the current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, transformer prior model 520 is implemented as software stored in memory unit 515 and executable by processor unit 505, as firmware, as one or more hardware circuits, or as a combination thereof. According to some aspects, transformer prior model 520 obtains a text prompt describing an image element. In some examples, transformer prior model 520 generates an image embedding based on the text prompt, where the image embedding represents visual features of the image element.

In some examples, transformer prior model 520 tokenizes the text prompt to obtain a set of text tokens, where the image embedding is generated based on the set of text tokens. In some examples, transformer prior model 520 generates a set of text token embeddings based on the set of text tokens, respectively, where each of the set of text token embeddings represent text features, and where the image embedding is generated based on the set of text token embeddings.

In some examples, transformer prior model 520 generates a set of partial image embeddings corresponding to the set of text tokens, respectively, where each of the set of partial image embeddings represents partial visual features. In some examples, transformer prior model 520 combines the set of partial image embeddings to obtain the image embedding. In some examples, transformer prior model 520 obtains a position embedding for each of the set of text tokens, where the image embedding is generated based on the position embedding. In some aspects, the transformer prior model 520 is trained to generate image embeddings using a training set including a training text prompt and a ground-truth image embedding.

According to some aspects, transformer prior model 520 generates a training image embedding based on the training text prompt. In some examples, transformer prior model 520 obtains a text prompt. In some examples, transformer prior model 520 generates a predicted image embedding based on the text prompt. In some aspects, the transformer prior model 520 includes parameters stored in a non-transitory computer readable medium that are optimized during the training.

According to some aspects, transformer prior model 520 comprises parameters stored in the at least one memory and trained to generate an image embedding based on a text prompt describing an image element, where the image embedding represents visual features of the image element. In some aspects, the transformer prior model 520 includes a tokenization component configured to tokenize the text prompt to obtain a set of text tokens, where the image embedding is generated based on the set of text tokens.

In some aspects, the transformer prior model 520 includes a first neural network layer trained to generate a set of text token embeddings corresponding to the set of text tokens, respectively. In some aspects, the transformer prior model 520 includes a second neural network layer trained to generate a set of intermediate embeddings corresponding to the set of text token embeddings, respectively. In some cases, the transformer prior model 520 includes a plurality of intermediate transformer layers trained to generate a plurality of intermediate embeddings, respectively. In some aspects, the transformer prior model 520 includes a third neural network layer trained to generate a set of partial image embeddings corresponding to the set of intermediate embeddings, respectively. Transformer prior model 520 is an example of, or includes aspects of, the corresponding element described with reference to FIGS. 6 and 7.

According to some aspects, image generation model 525 is implemented as software stored in memory unit 515 and executable by processor unit 505, as firmware, as one or more hardware circuits, or as a combination thereof. According to some aspects, image generation model 525 generates a synthetic image depicting the image element based on the image embedding. In some examples, image generation model 525 obtains a noise input. In some examples, image generation model 525 denoises the noise input based on the image embedding to generate the synthetic image. According to some aspects, image generation model 525 generates a synthetic image based on the predicted image embedding.

According to some aspects, image generation model 525 comprises parameters stored in the at least one memory and configured to generate a synthetic image depicting the image element based on the image embedding. In some aspects, the image generation model 525 includes a diffusion model. Image generation model 525 is an example of, or includes aspects of, the corresponding element described with reference to FIG. 6. Image generation model 525 is an example of, or includes aspects of, the diffusion model described with reference to FIG. 8.

According to some aspects, user interface 530 is configured to display the synthetic image. A user interface 530 or UI is the point of interaction between a user (e.g., the user 100 described with reference to FIG. 1) and a computer system (e.g., the machine learning system 600 described with reference to FIG. 6 or the computing device 1400 described with reference to FIG. 14). In some cases, the UI includes visual elements like menus, icons, buttons, and text fields. The UI is designed to make the interaction of a user with software or hardware intuitive and efficient, aiming to enhance usability and improve the overall user experience.

According to some aspects, training component 535 is implemented as software stored in memory unit 515 and executable by processor unit 505, as firmware, as one or more hardware circuits, or as a combination thereof. According to some embodiments, training component 535 is implemented as software stored in a memory unit and executable by a processor in the processor unit of a separate computing device, as firmware in the separate computing device, as one or more hardware circuits of the separate computing device, or as a combination thereof. In some examples, training component 535 is part of another apparatus other than image processing apparatus 500 and communicates with the image processing apparatus 500. In some examples, training component 535 is part of image processing apparatus 500.

According to some aspects, training component 535 obtains a training set including a training text prompt and a ground-truth image embedding, where the training text prompt describes an image element. In some examples, training component 535 trains, using the training set and the training image embedding, a transformer prior model 520 to generate an image embedding that represents visual features of the image element. In some examples, training component 535 computes a loss based on the ground-truth image embedding and the training image embedding. In some examples, training component 535 updates parameters of the transformer prior model 520 based on the loss. In some aspects, the loss includes a mean squared error (MSE) loss. In some aspects, the transformer prior model 520 is trained independently of the image generation model 525.

FIG. 6 shows an example of a text-to-image generation system according to aspects of the present disclosure. The example shown includes machine learning system 600, text prompt 605, transformer prior model 610, image embedding 615, noise input 620, image generation model 625, and synthetic image 630.

The transformer prior model 610 may be used to generate guidance that can be used to condition the output of the image generation model 625. For example, the transformer prior model 610 may influence the distribution of generated images by conditioning the image generation model 625 on additional information such as text prompts, style cues, or other forms of input that provide context. In some embodiments, the transformer prior model 610 is a generative model that generates variable guidance to increase the diversity of outputs from the image generation model 625. In some embodiments, the transformer prior model 610 generates guidance in an embedding space that the image generation model 625 takes as input.

In short, the prior model provides a probabilistic foundation or context for the image generation model, allowing it to generate images that are more aligned with the input constraints and user expectations.

Referring to FIG. 6, the machine learning system 600 receives text prompt 605 and generates a synthetic image 630. For example, the text prompt 605 states “Closeup of two hedgehogs walking along the side of a busy highway”. In some embodiments, the text prompt 605 is provided to a transformer prior model 610 to generate image embedding 615. In some cases, the transformer prior model 610 directly generates image embedding 615 based on the text prompt 605. Further detail on generating the image embedding 615 using the transformer prior model 610 is described with reference to FIG. 7.

In some embodiments, the image generation model 625 receives the image embedding and the noise input 620 to generate synthetic image 630. In some cases, for example, the image generation model 625 includes a diffusion model. The image generation model 625 generates an output image (e.g., the synthetic image 630) from a random noise input (e.g., the noise input 620). In some cases, the random noise input may be sampled from a Gaussian distribution. In some cases, the random noise input may include a noisy image stored in a database or a noisy training image stored in a database. Then, the image generation model 625 performs a reverse diffusion process, which iteratively refines the noisy image by predicting and removing noise at each diffusion timestep. The reverse diffusion process gradually transforms the random noise (or noise input 620) into a coherent image (e.g., the synthetic image 630).

In some embodiments, the reverse diffusion process is guided based on a conditional guidance embedding. For example, the image generation model 625 receives the image embedding 615 to guide the reverse diffusion process. In one aspect, the image embedding 615 is added to the U-Net of the image generation model through a cross-attention mechanism to guide the reverse diffusion process, so that the output aligns with the visual features encoded in the image embedding 615. In some cases, the guidance ensures that the synthetic image 630 aligns with the specified condition (e.g., the text prompt 605). During the final reverse diffusion timestep, the image generation model 625 outputs a fully denoised image (e.g., the synthetic image 630) that matches the distribution of the original training data and aligns with the input conditioning. Further detail on the image generation model 625 is described with reference to FIG. 8.

Text prompt 605 is an example of, or includes aspects of, the corresponding element described with reference to FIGS. 3, 7, and 8. Transformer prior model 610 is an example of, or includes aspects of, the corresponding element described with reference to FIGS. 5 and 7. Image embedding 615 is an example of, or includes aspects of, the corresponding element described with reference to FIG. 7.

Image generation model 625 is an example of, or includes aspects of, the corresponding element described with reference to FIG. 5. Synthetic image 630 is an example of, or includes aspects of, the corresponding element described with reference to FIG. 3.

FIG. 7 shows an example of a transformer prior model 700 according to aspects of the present disclosure. The example shown includes transformer prior model 700, text prompt 705, tokenization component 710, text tokens 715, first neural network layer 720, text token embeddings 725, second neural network layer 730, intermediate embeddings 735, third neural network layer 740, partial image embeddings 745, and image embedding 750. According to some embodiments, the transformer prior model 700 includes a tokenization component 710, a first neural network layer 720, a second neural network layer 730, and a third neural network layer 740.

Referring to FIG. 7, the transformer prior model 700 is trained to generate image embedding 750 based on a text prompt 705. For example, the text prompt 705 states “Closeup of two hedgehogs walking along the side of a busy highway”. In some embodiments, the tokenization component 710 tokenizes the text prompt 705 into a set of text tokens 715. For example, the first text token (e.g., Text Token 1 depicted in FIG. 7) may include the word “closeup”, and the second text token (e.g., Text Token 2) may include the word “of”, and the last text token (e.g., Text Token L) may include the word “highway”. In some cases, the tokenization component 710 may tokenize the text prompt 705 into text tokens 715 each including a group of words. For example, the first text token may include the words “closeup of”, the second token may include the words “two hedgehogs”, and the last text token may include the words “side of a busy highway”.

According to some embodiments, the tokenization component 710 may tokenize the text prompt 705 based on parts of the sequence are more important relative to each words or phrases within the text prompt 705. For example, the tokenization component 710 may identify the object “two hedgehogs” as the most important, the scene “side of a busy highway” as the second most important, and so on. Then, the tokenization component 710 may tokenize the text prompt 705 into a plurality of text tokens 715. For example, the first text token may include the group of words “two hedgehogs”, the second text token may include the group of words “side of a busy highway”, and the last text token may include the words “walking along” or “closeup of”.

In some aspects, the transformer prior model 700 includes a plurality of neural network layers (e.g., a first neural network layer 720, a second neural network layer 730, and a third neural network layer 740) that are trained to convert the text tokens 715 into the image embedding 750. For example, the first neural network layer 720 generates the text token embeddings 725 based on the text tokens 715, respectively. In some cases, each of the text token embeddings 725 represents textual features of the corresponding text token. In some embodiments, a T5 text encoder is configured to generate a plurality of T5 text token embeddings based on the text tokens 715, respectively. In some embodiments, the plurality of T5 text token embeddings is combined with the plurality of text token embeddings 725, respectively, to generate augmented text token embeddings. In some cases, the image embedding 750 is generated based on the augmented text token embeddings. According to some embodiments, a plurality of position embeddings is combined with the plurality of text tokens 715, respectively. In some cases, the position embeddings are used to help the transformer prior model 700 to understand the words in a sequence.

According to some embodiments, the second neural network layer 730 generates intermediate embeddings 735 based on the text token embeddings 725, respectively. For example, each of the intermediate embeddings 735 represents a combination of partial textual feature and partial image feature of the corresponding text token. In some embodiments, a second intermediate embedding among the intermediate embeddings 735 is weighted more than the first intermediate embedding among the intermediate embeddings 735. For example, the first intermediate embedding may be generated based on the first text token embedding. The second intermediate embedding may be generated based on the first text token embedding and a second text token embedding. In some cases, the last intermediate embedding is generated based on a combination of each of the text token embeddings 725.

In some embodiments, the third neural network layer 740 generates partial image embeddings 745 based on the intermediate embeddings 735, respectively. For example, each of the partial image embeddings 745 represents image features of the corresponding text token. For example, the first partial image embedding may represent visual features or a style of “closeup”, the second partial image embedding may represent visual features of the object “two hedgehogs”, and the last partial image embedding may represent visual features of the scene “side of a busy sideway.” According to some embodiments, the transformer prior model 700 combines the partial image embeddings 745 to generate the image embedding 750. In some cases, the image embedding 750 represents the visual features of one or more image elements described in the text prompt 705. Accordingly, the image embedding 750 is provided to an image generation model to generate a synthetic image as described with reference to FIG. 6.

Transformer prior model 700 is an example of, or includes aspects of, the corresponding element described with reference to FIGS. 5 and 6. Text prompt 705 is an example of, or includes aspects of, the corresponding element described with reference to FIGS. 3, 6, and 8. Image embedding 750 is an example of, or includes aspects of, the corresponding element described with reference to FIG. 6.

FIG. 8 shows an example of an image generation model according to aspects of the present disclosure. The example shown includes diffusion model 800, original image 805, pixel space 810, image encoder 815, original image feature 820, latent space 825, forward diffusion process 830, noisy feature 835, reverse diffusion process 840, denoised image feature 845, image decoder 850, output image 855, text prompt 860, text encoder 865, guidance feature 870, and guidance space 875.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 800 may take an original image 805 in a pixel space 810 as input and apply an image encoder 815 to convert original image 805 into original image feature 820 in a latent space 825. Then, a forward diffusion process 830 gradually adds noise to the original image feature 820 to obtain noisy feature 835 (also in latent space 825) at various noise levels.

Next, a reverse diffusion process 840 (e.g., a U-Net ANN) gradually removes the noise from the noisy feature 835 at the various noise levels to obtain the denoised image feature 845 in latent space 825. In some examples, denoised image feature 845 is compared to the original image feature 820 at each of the various noise levels, and parameters of the reverse diffusion process 840 of the diffusion model are updated based on the comparison. Finally, an image decoder 850 decodes the denoised image feature 845 to obtain an output image 855 in pixel space 810. In some cases, an output image 855 is created at each of the various noise levels. The output image 855 can be compared to the original image 805 to train the reverse diffusion process 840. In some cases, output image 855 refers to the synthetic image (e.g., described with reference to FIGS. 3 and 6).

In some cases, image encoder 815 and image decoder 850 are pre-trained prior to training the reverse diffusion process 840. In some examples, image encoder 815 and image decoder 850 are trained jointly, or the image encoder 815 and image decoder 850 are fine-tuned jointly with the reverse diffusion process 840.

The reverse diffusion process 840 can also be guided based on a text prompt 860, or another guidance prompt, such as an image, a layout, a style, a color, a segmentation map, etc. The text prompt 860 can be encoded using a text encoder 865 (e.g., a multimodal encoder) to obtain guidance feature 870 in guidance space 875. The guidance feature 870 can be combined with the noisy feature 835 at one or more layers of the reverse diffusion process 840 to ensure that the output image 855 includes content described by the text prompt 860. For example, guidance feature 870 can be combined with the noisy feature 835 using a cross-attention block within the reverse diffusion process 840.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features. Further detail on the U-Net is described with reference to FIG. 9.

A diffusion process may also be modified based on conditional guidance. In some cases, a user provides a text prompt (e.g., text prompt 860) describing content to be included in a generated image. In some examples, guidance can be provided in a form other than text, such as via an image, a sketch, a color, a style, or a layout. The system converts text prompt 860 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 800 generates an image based on the noise map and the conditional guidance vector.

A diffusion process can include both a forward diffusion process 830 for adding noise to an image (e.g., original image 805) or features (e.g., original image feature 820) in a latent space 825 and a reverse diffusion process 840 for denoising the images (or features) to obtain a denoised image (e.g., output image 855). The forward diffusion process 830 can be represented as q(xₜ|xₜ₋₁), and the reverse diffusion process 840 can be represented as p_{θ}(xₜ₋₁|xₜ). Further detail on the diffusion process is described with reference to FIG. 10.

A diffusion model 800 may be trained using both a forward diffusion process 830 and a reverse diffusion process 840. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 830 in N stages. In some cases, the forward diffusion process 830 is a fixed process where Gaussian noise is successively added to an image. In latent diffusion models, the Gaussian noise may be successively added to features (e.g., original image feature 820) in a latent space 825.

At each stage n, starting with stage N, a reverse diffusion process 840 is used to predict the image or image features at stage n−1. For example, the reverse diffusion process 840 can predict the noise that was added by the forward diffusion process 830, and the predicted noise can be removed from the image to obtain the predicted image. In some cases, an original image 805 is predicted at each stage of the training process.

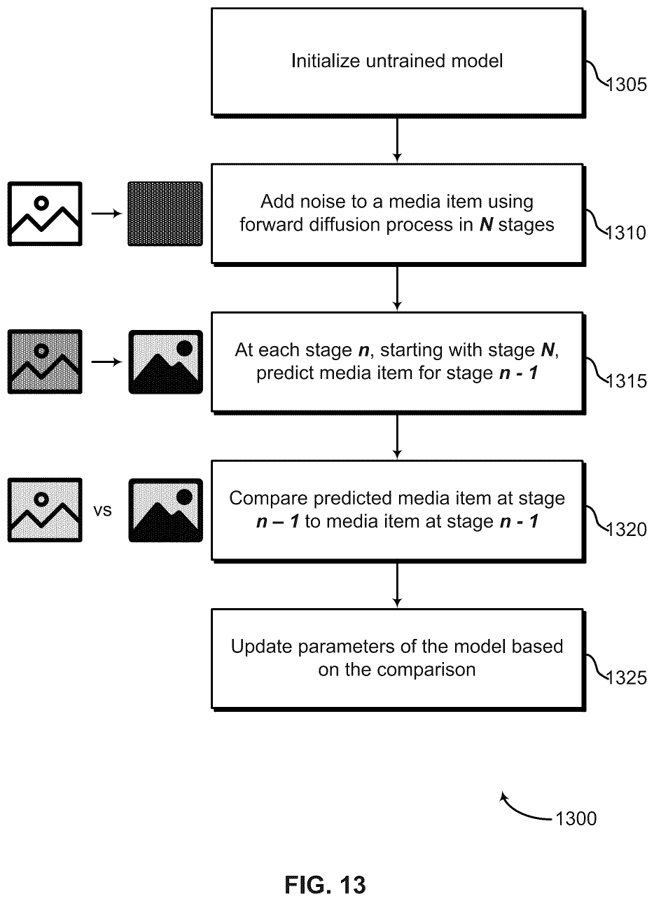

The training component (e.g., training component described with reference to FIG. 5) compares predicted image (or image features) at stage n−1 to an actual image (or image features), such as the image at stage n−1 or the original input image. For example, given observed data x, the diffusion model 800 may be trained to minimize the variational upper bound of the negative log-likelihood −log p_{θ}(x) of the training data. The training component then updates parameters of the diffusion model 800 based on the comparison. For example, parameters of a U-Net may be updated using gradient descent. Time-dependent parameters of the Gaussian transitions can also be learned. Further detail on training the diffusion model is described with reference to FIG. 13.

Original image 805 is an example of, or includes aspects of, the corresponding element described with reference to FIG. 10. Forward diffusion process 830 is an example of, or includes aspects of, the corresponding element described with reference to FIG. 10. Reverse diffusion process 840 is an example of, or includes aspects of, the corresponding element described with reference to FIG. 10. Text prompt 860 is an example of, or includes aspects of, the corresponding element described with reference to FIGS. 3, 6, and 7.

FIG. 9 shows an example of a U-Net 900 architecture according to aspects of the present disclosure. The example shown includes U-Net 900, input feature 905, initial neural network layer 910, intermediate feature 915, down-sampling layer 920, down-sampled feature 925, up-sampling process 930, up-sampled feature 935, skip connection 940, final neural network layer 945, and output feature 950.

In some examples, U-Net 900 is an example of the component that performs the reverse diffusion process 840 of diffusion model 800 described with reference to FIG. 8 and includes architectural elements of the image generation model 525 described with reference to FIG. 5. The U-Net 900 depicted in FIG. 9 is an example of, or includes aspects of, the architecture used within the reverse diffusion process described with reference to FIG. 8.

In some examples, diffusion models are based on a neural network architecture known as a U-Net. The U-Net 900 takes input feature 905 having an initial resolution and an initial number of channels, and processes the input feature 905 using an initial neural network layer 910 (e.g., a convolutional network layer) to produce intermediate feature 915. The intermediate feature 915 is then down-sampled using a down-sampling layer 920 such that the down-sampled feature 925 has a resolution less than the initial resolution and a number of channels greater than the initial number of channels.

This process is repeated multiple times, and then the process is reversed. For example, the down-sampled feature 925 is up-sampled using up-sampling process 930 to obtain up-sampled feature 935. The up-sampled feature 935 can be combined with intermediate feature 915 having the same resolution and number of channels via a skip connection 940. These inputs are processed using a final neural network layer 945 to produce output feature 950. In some cases, the output feature 950 has the same resolution as the initial resolution and the same number of channels as the initial number of channels.

In some cases, U-Net 900 takes an additional input feature to produce conditionally generated output. For example, the additional input feature could include a vector representation of an input prompt. The additional input feature can be combined with the intermediate feature 915 within the neural network at one or more layers. For example, a cross-attention module can be used to combine the additional input features and the intermediate feature 915.

### Diffusion Process

FIG. 10 shows an example of a diffusion process 1000 according to aspects of the present disclosure. The example shown includes diffusion process 1000, forward diffusion process 1005, reverse diffusion process 1010, noisy image 1015, first intermediate image 1020, second intermediate image 1025, and original image 1030.

Diffusion process 1000 can include forward diffusion process 1005 for adding noise to original image 1030 (e.g., original image 805 described with reference to FIG. 8) or features (e.g., original image feature 820 described with reference to FIG. 8) in a latent space. In some aspects, diffusion process 1000 includes reverse diffusion process 1010 for denoising the noisy image 1015 (or image features) to obtain a denoised image (or original image 1030). The forward diffusion process 1005 can be represented as q(xₜ|xₜ₋₁), and the reverse diffusion process 1010 can be represented as p_{θ}(xₜ₋₁|xₜ). In some cases, the forward diffusion process 1005 is used during training to generate images with successively greater noise, and a neural network is trained to perform the reverse diffusion process 1010 (e.g., to successively remove the noise).

In an example forward diffusion process 1005 for a latent diffusion model (e.g., diffusion model 800 described with reference to FIG. 8), the diffusion model maps an observed variable x₀ (either in a pixel space or a latent space) to obtain intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 1010. During the reverse diffusion process 1010, the diffusion model begins with noisy data x_{T}, such as a noisy image 1015 and denoises the data to obtain the p_{θ}(xₜ₋₁|xₜ). At each step t−1, the reverse diffusion process 1010 takes xₜ, such as the first intermediate image 1020, and t as input. Here, t represents a step in the sequence of transitions associated with different noise levels, The reverse diffusion process 1010 outputs xₜ₋₁, such as the second intermediate image 1025, iteratively until x_{T} is reverted back to x₀, the original image 1030. The reverse diffusion process 1010 can be represented as:

$${p}_{θ} ( {x}_{t - 1} \vert {x}_{t} ) : = N ( {x}_{t - 1} ; {μ}_{θ} ( {x}_{t} , t ) , {Σ}_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) : = p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, 1) is the pure noise distribution as the reverse diffusion process 1010 takes the outcome of the forward diffusion process 1005, a sample of pure noise, as input and

$${\prod }_{t = I}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

Forward diffusion process 1005 is an example of, or includes aspects of, the corresponding element described with reference to FIG. 8. Reverse diffusion process 1010 is an example of, or includes aspects of, the corresponding element described with reference to FIG. 8. Original image 1030 is an example of, or includes aspects of, the corresponding element described with reference to FIG. 8.

### Training and Evaluation

In FIGS. 11-13, a method, apparatus, non-transitory computer readable medium, and system for image processing include obtaining a training set comprising a training text prompt and a ground-truth image embedding, where the training text prompt describes an image element, generating a training image embedding based on the training text prompt, and training, using the training set and the training image embedding, a transformer prior model to generate an image embedding that represents visual features of the image element.

Some examples of the method, apparatus, non-transitory computer readable medium, and system further include generating a ground-truth image embedding based on the ground-truth image, generating a predicted image embedding based on the text prompt, and computing a loss based on the ground-truth image embedding and the training image embedding. Some examples further include updating parameters of the transformer prior model based on the loss. In some aspects, the loss comprises a mean squared error (MSE) loss.

Some examples of the method, apparatus, non-transitory computer readable medium, and system further include obtaining a text prompt. Some examples further include generating a predicted image embedding based on the text prompt. Some examples further include generating, using an image generation model, a synthetic image based on the predicted image embedding.

In some aspects, the transformer prior model is trained independent of the image generation model. In some aspects, the transformer prior model comprises parameters stored in a non-transitory computer readable medium that are optimized during the training.

FIG. 11 shows an example of a method 1100 for training a transformer prior model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1105, the system obtains a training set including a text prompt and a ground-truth image, where the text prompt describes an image element. In some cases, the operations of this step refer to, or may be performed by, a training component as described with reference to FIG. 5. In some cases, for example, a paired training set including a text description of an image and a corresponding image embedding is provided to the training component to train the transformer prior model. For example, the text description is used as input text prompt to the transformer prior model to generate a predicted image embedding, and the image embedding is used as ground-truth image embedding to compare the discrepancy between the predicted image embedding and the ground-truth image embedding.

In some cases, the transformer prior model is trained to generate the image embedding as described with reference to FIG. 7. In some embodiments, the transformer prior model is trained independently of the image generation model. According to some embodiments, the transformer prior model is trained by merging frozen T5 token embeddings (described with reference to FIG. 7) with learnable token embeddings. In some cases, the T5 embeddings are linearly projected into the same space as the learnable token embeddings and the two types of embeddings are combined. In some cases, the embedding of the last token from the final layer of the transformer prior model is linearly projected into the same embedding space as the image embedding space to generated the predicted image embedding.

At operation 1110, the system trains, using the training set, a transformer prior model to generate an image embedding that represents visual features of the image element based on the text prompt. In some cases, the operations of this step refer to, or may be performed by, a training component as described with reference to FIG. 5. In some cases, the training component computes a loss based on the ground-truth image embedding and the training image embedding. In some cases, the parameters of the transformer prior model is updated based on the loss. In one aspect, the loss includes a mean squared error (MSE) loss. In some cases, MSE loss calculates the average of the squares of the differences between corresponding elements of the ground-truth image embedding and the predicted image embedding. In some cases, a large difference is penalized heavily to promote closer alignment of the two outputs.

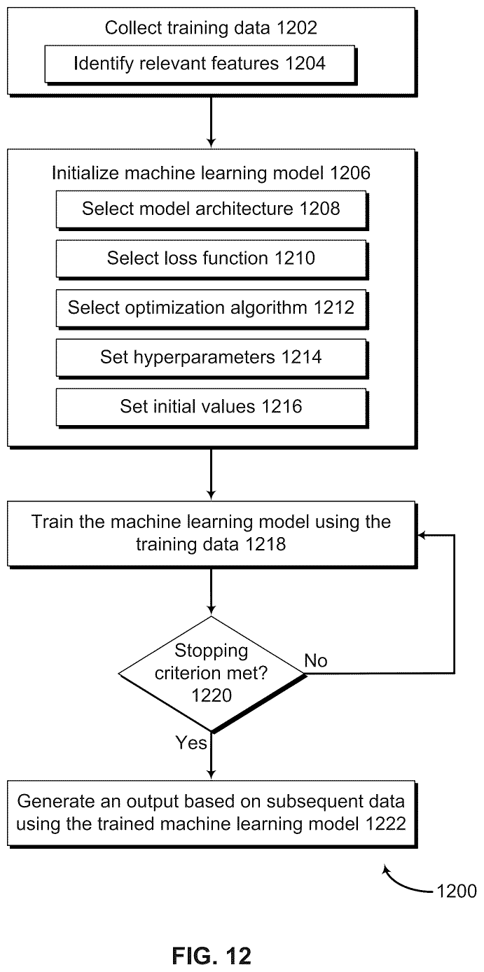

FIG. 12 shows an example of a flow diagram depicting an algorithm as a step-by-step procedure in an example implementation of operations performable for training a machine learning model according to aspects of the present disclosure. In some embodiments, the procedure 1200 describes an operation of the training component 535 described for configuring the image generation model 525 as described with reference to FIG. 5. The procedure 1200 provides one or more examples of generating training data, use of the training data to train a machine-learning model, and use of the trained machine-learning model to perform a task.

To begin in this example, a machine-learning system collects training data (block 1202) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1204) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1206). Initialization of the machine-learning model includes selecting a model architecture (block 1208) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1210). The loss function is utilized to measure a difference between an output of the machine-learning model (e.g., the model predictions) and target values (e.g., as expressed by the training data) to be used to train the machine-learning model. Additionally, an optimization algorithm is selected (block 1212) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1216) examples of which include initializing weights and biases of nodes to improve efficiency in training and computational resources consumption as part of training. Hyperparameters are also set (block 1214) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1218) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1220), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), procedure 1200 continues the training of the machine-learning model using the training data (block 1218) in this example.

If the stopping criterion is met (“yes” from decision block 1220), the trained machine-learning model is then utilized to generate an output based on subsequent data (block 1222). The trained machine-learning model, for instance, is trained to perform a task as described above and therefore once trained is configured to perform that task based on subsequent data received as an input and processed by the machine-learning model.

FIG. 13 shows an example of a method 1300 for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In some embodiments, the method 1300 describes an operation of the training component 535 described for training the image generation model 525 as described with reference to FIG. 5. The method 1300 represents an example for training a reverse diffusion process as described above with reference to FIG. 10. In some examples, these operations are performed by a system including a processor executing a set of codes to control functional elements of an apparatus, such as the image generation model described in FIG. 5.

At operation 1305, the system initializes untrained model. In some cases, the operations of this step refer to, or may be performed by, a training component as described with reference to FIG. 5. Initialization can include defining the architecture of the model and establishing initial values for the model parameters. In some cases, the initialization can include defining hyper-parameters such as the number of layers, the resolution and channels of each layer block, the location of skip connections, and the like.

At operation 1310, the system adds noise to media item using forward diffusion process in N stages. In some cases, the operations of this step refer to, or may be performed by, a training component as described with reference to FIG. 5. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1315, the system at each stage n, starting with stage N, predict media item for stage n−1. In some cases, the operations of this step refer to, or may be performed by, a training component as described with reference to FIG. 5. In some cases, the media item is a synthetic image generated using the image generation model. For example, the reverse diffusion process can predict the noise that was added by the forward diffusion process, and the predicted noise can be removed from the noise input to obtain the predicted output. In some cases, an original media item is predicted at each stage of the training process.

At operation 1320, the system compares the predicted media item (or feature) at stage n−1 to media at stage n−1. In some cases, for example, the system compares the synthetic image (or predicted image feature) at state n−1 to the ground-truth image (or ground-truth feature) at state n−1. In some cases, the operations of this step refer to, or may be performed by, a training component as described with reference to FIG. 5. For example, given observed data x, the diffusion model may be trained to minimize the variational upper bound of the negative log-likelihood −log p_{θ}(x) of the training data.

At operation 1325, the system updates parameters of the model based on the comparison. In some cases, the operations of this step refer to, or may be performed by, a training component as described with reference to FIG. 5. For example, parameters of a U-Net may be updated using gradient descent. Time-dependent parameters of the Gaussian transitions can also be learned.

### Computing Device

FIG. 14 shows an example of a computing device 1400 according to aspects of the present disclosure. The example shown includes computing device 1400, processor 1405, memory subsystem 1410, communication interface 1415, I/O interface 1420, user interface component 1425, and channel 1430.

In some embodiments, computing device 1400 is an example of, or includes aspects of, the image processing apparatus described with reference to FIGS. 1 and 5. In some embodiments, computing device 1400 includes processor 1405 that can execute instructions stored in memory subsystem 1410 to obtain a text prompt, generate an image embedding, and generate a synthetic image.

According to some embodiments, processor 1405 includes one or more processors. In some cases, processor 1405 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1405 is configured to operate a memory array using a memory controller. In other cases, a memory controller is integrated into processor 1405. In some cases, processor 1405 is configured to execute computer-readable instructions stored in a memory to perform various functions. In some embodiments, processor 1405 includes special-purpose components for modem processing, baseband processing, digital signal processing, or transmission processing. Processor 1405 is an example of, or includes aspects of, the processor unit described with reference to FIG. 5.

According to some embodiments, memory subsystem 1410 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1410 is an example of, or includes aspects of, the memory unit described with reference to FIG. 5.

According to some embodiments, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1415.

According to some embodiments, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or hardware components controlled by the I/O controller. I/O interface 1420 is an example of, or includes aspects of, the I/O module described with reference to FIG. 5.

According to some embodiments, user interface component 1425 enables a user to interact with computing device 1400. In some cases, user interface component 1425 includes an audio device, such as an external speaker system, an external display device such as a display screen, an input device (e.g., a remote-control device interfaced with a user interface directly or through the I/O controller), or a combination thereof. User interface component 1425 is an example of, or includes aspects of, the user interface described with reference to FIG. 5.

The performance of apparatus, systems, and methods of the present disclosure have been evaluated, and results indicate embodiments of the present disclosure have obtained increased performance over conventional technology (e.g., conventional image generation models). Example experiments demonstrate that the image processing apparatus based on the present disclosure outperforms conventional image generation models. Details on the example use cases based on embodiments of the present disclosure are described with reference to FIG. 3.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a text prompt describing an image element;
generating, using a transformer prior model, an image embedding based on the text prompt, wherein the image embedding represents visual features of the image element; and
generating, using an image generation model, a synthetic image depicting the image element based on the image embedding.

2. The method of claim 1, wherein generating the image embedding comprises:
tokenizing the text prompt to obtain a plurality of text tokens, wherein the image embedding is generated based on the plurality of text tokens.

3. The method of claim 2, wherein generating the image embedding comprises:
generating a plurality of text token embeddings based on the plurality of text tokens, respectively, wherein each of the plurality of text token embeddings represent text features, and wherein the image embedding is generated based on the plurality of text token embeddings.

4. The method of claim 2, wherein generating the image embedding comprises:
generating a plurality of partial image embeddings corresponding to the plurality of text tokens, respectively, wherein each of the plurality of partial image embeddings represents partial visual features; and
combining the plurality of partial image embeddings to obtain the image embedding.

5. The method of claim 2, wherein generating the image embedding comprises:
obtaining a position embedding for each of the plurality of text tokens, wherein the image embedding is generated based on the position embedding.

6. The method of claim 1, wherein generating the synthetic image comprises:
obtaining a noise input; and
denoising the noise input based on the image embedding to generate the synthetic image.

7. The method of claim 1, wherein:
the transformer prior model is trained to generate image embeddings using a training set comprising a training text prompt and a ground-truth image embedding.

8. A method of training a machine learning model, the method comprising:
obtaining a training set including a text prompt and a ground-truth image, wherein the text prompt describes an image element; and
training, using the training set, a transformer prior model to generate an image embedding based on the text prompt, wherein the image embedding represents visual features of the image element.

9. The method of claim 8, further comprising:
generating a ground-truth image embedding based on the ground-truth image;
generating a predicted image embedding based on the text prompt;
computing a loss based on the ground-truth image embedding and the predicted image embedding; and
updating parameters of the transformer prior model based on the loss.

10. The method of claim 9, wherein:
the loss comprises a mean squared error (MSE) loss.

11. The method of claim 8, further comprising:
generating, using an image generation model, a synthetic image based on the image embedding.

12. The method of claim 11, wherein:
the transformer prior model is trained independent of the image generation model.

13. The method of claim 8, wherein:
the transformer prior model comprises parameters stored in a non-transitory computer readable medium that are optimized during the training.

14. An apparatus comprising:
a memory component;
a processing device coupled to the memory component;
a transformer prior model comprising parameters stored in the memory component and trained to generate an image embedding based on a text prompt, wherein the image embedding represents visual features of the image element; and
an image generation model comprising parameters stored in the memory component and trained to generate a synthetic image depicting the image element based on the image embedding.

15. The apparatus of claim 14, wherein:
the system comprises a tokenization component configured to tokenize the text prompt to obtain a plurality of text tokens, wherein the image embedding is generated based on the plurality of text tokens.

16. The apparatus of claim 15, wherein:
the transformer prior model comprises a first transformer layer trained to generate a plurality of text token embeddings corresponding to the plurality of text tokens, respectively.

17. The apparatus of claim 16, wherein:
the transformer prior model comprises a second transformer layer trained to generate a plurality of intermediate embeddings corresponding to the plurality of text token embeddings, respectively.

18. The apparatus of claim 17, wherein:
the transformer prior model comprises a third transformer layer trained to generate a plurality of partial image embeddings corresponding to the plurality of intermediate embeddings, respectively.

19. The apparatus of claim 14, wherein:
the image generation model includes a diffusion model.

20. The apparatus of claim 14, further comprising:
a user interface configured to display the synthetic image.
